(19) United States
(12) Patent Application Publication
(10) Pub. No.: US 2010/0207082 A1
(43) Pub. Date: Aug. 19, 2010

(54) Tool with Prying and Clamping Devices

(76) Inventor: Mou-Tang LIOU, Ta Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/371,652

(22) Filed: Feb. 16, 2009

(51) Int. Cl. B66F 15/00

(52) U.S. Cl. 254/131

(57) ABSTRACT

A tool includes a handle and a prying device pivotally connected to the handle and positionable at various pivoting positions with respect to the handle. The prying device is engagable with an item to be pried and the handle is utilized as a lever to extract the item efficiently. The tool also includes a clamping device adjustably positionable on the handle, and the clamping device and prying device are cooperatable to hold an item therebetween.

### BACKGROUND OF THE INVENTION

1. Field of the Invention

The present invention relates to a tool having a prying device which includes prongs for extracting an element to be pried and a clamping device which includes a holding member that cooperates with the prongs for clamping an element.

2. Description of the Related Art

A tool, generally known as crowbar, includes a straight bar and a working end slightly bent with respect to the bar and forked. In operation, the working end is engaged with an element to be extracted and the straight bar is used as a lever to pivot about a fulcrum.

This tool is commonly used by a worker such as a carpenter and since the carpenter uses a clamping device often too, but the clamping device takes space of carpenter's tool box and is liable to get mislaid.

The present invention is, therefore, intended to obviate or at least alleviate the problems encountered in the prior art.

### SUMMARY OF THE INVENTION

According to the present invention, a tool includes a handle and a prying device pivotally connected to the handle and positionable at various pivoting positions with respect to the handle. The prying device is engagable with an item to be pried and the handle is utilized as a lever to extract the item efficiently. The tool also includes a clamping device adjustably positionable on the handle, and the clamping device and prying device are cooperatable to hold an item therebetween.

It is an aspect of the present invention that the tool is usable for prying and clamping an item.

It is another aspect of the present invention that the tool has a simple structure and is manufactured cost-effectively.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a tool in accordance with the present invention.

FIG. 2 is an exploded perspective view of the tool shown in FIG. 1.

FIG. 3 is another exploded perspective view of the tool show in FIG. 1.

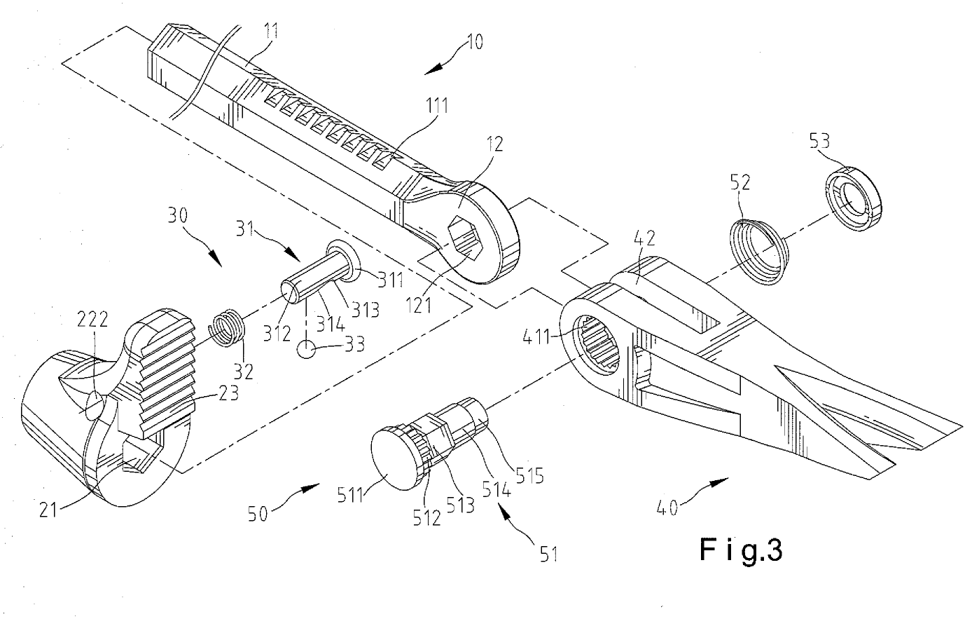

FIG. 4 is a cross-sectional view taken along line 4-4 of FIG. 1.

FIG. 5 is a cross-sectional view taken along line 5-5 of FIG. 1.

FIG. 6 is similar to FIG. 5, but showing a second positioning device of the tool in a position in which a prying device is operably pivotal with respect to a handle.

FIG. 7 is similar to FIG. 4, but showing a first positioning device of the tool in a position in which a clamping device is operably moveable on the handle.

FIG. 8 is a cross-sectional view showing the tool adapted for clamping an element.

FIG. 9 is an extended cross-sectional view of FIG. 8, showing the tool adapted for clamping an element with smaller dimensions.

### DETAILED DESCRIPTION OF THE PREFERRED EMBODIMENT

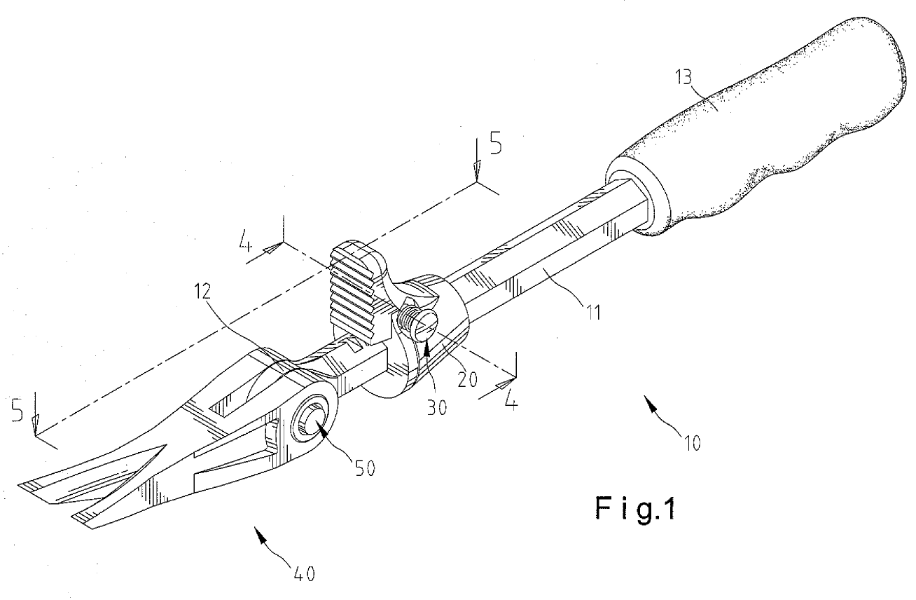

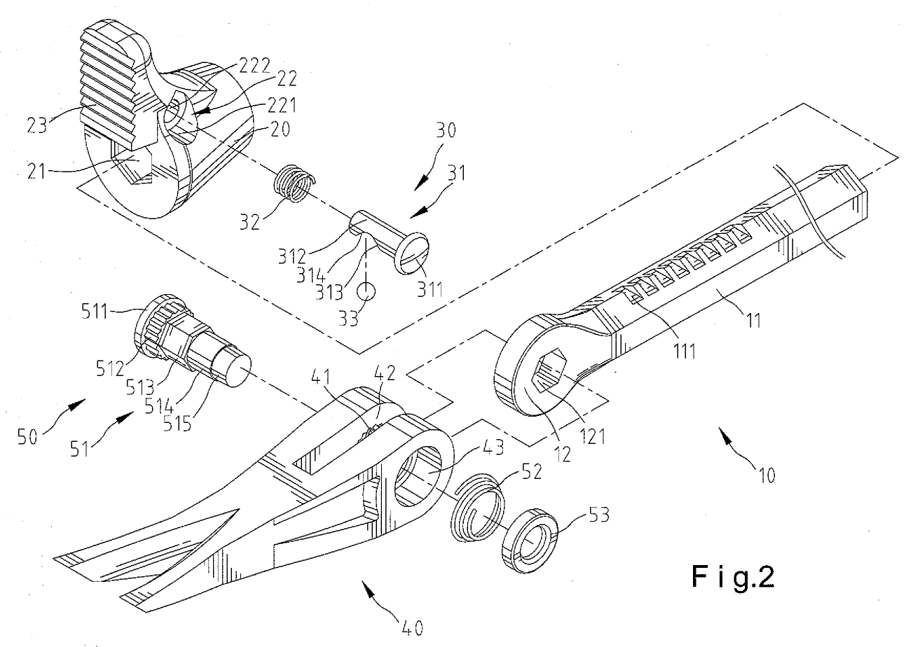

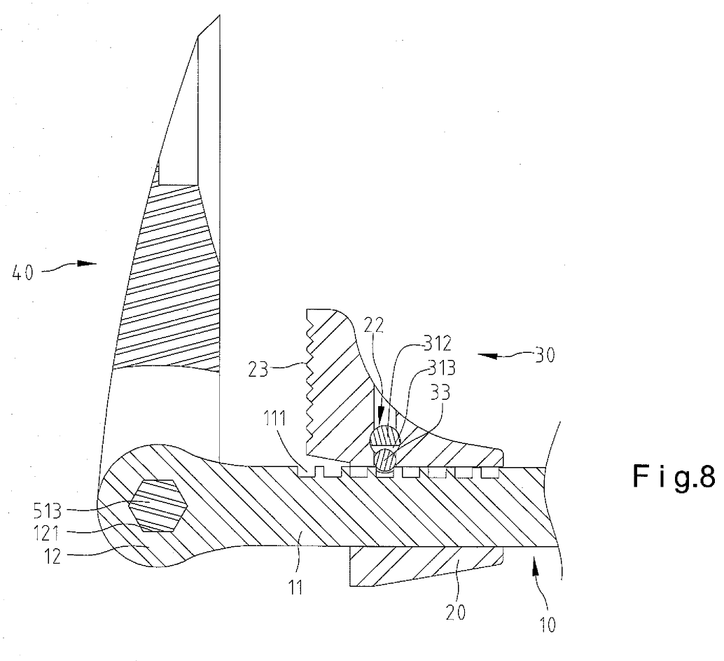

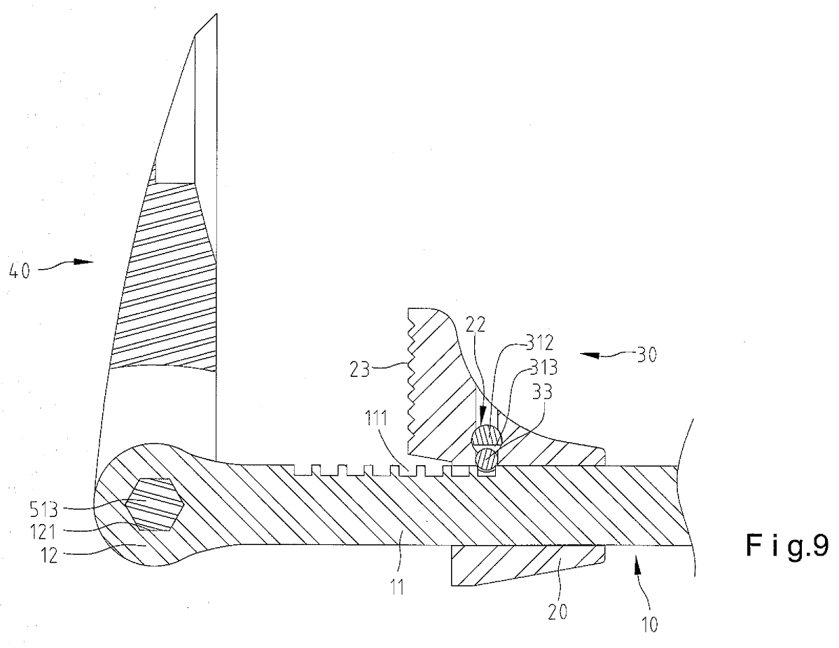

FIGS. 1 and 2 show a tool usable for prying and clamping an item in accordance with the present invention. The tool includes a handle 10 defining a body 11. In the preferred embodiment, the body 11 is in the form of a bar, which extends axially. The body 11 includes a pivoting end 12 and a prying device 40 is pivotally connected to the pivoting end 12 so that the prying device 40 is operably pivotal with respect to the handle 10. The prying device 40 includes a working end which is engagable with an element to be pried. The body 11 also includes a gripping end 13 which includes an ergonomically shaped gripping member. Moreover, the body 11 includes a clamping device 20 which is cooperatable with the prying device 40 to hold an item in a space therebetween (as shown in FIGS. 8 and 9), and the clamping device 20 is operably moveable and adjustably positionable on the handle 10. Preferably, the clamping device 20 is operably moveable between the pivoting end 12 and the gripping end 13. In this preferred embodiment, the clamping device 20 includes a handle hole 21 extending therethrough for moveably receiving the handle 10. Preferably, the handle hole 21 and the handle 10 have non-circular cross sections such that it prevents a relative rotation between the clamping device 20 and the handle 10. Preferably, the handle hole 21 and the handle 10 have the same cross sections.

In order to assist the clamping device 20 securely positions on the handle 10, the tool may include a first positioning device 30 which is operably moveable between an unlock position and a lock position, and the clamping device 20 is operably moveable on the handle 10 when the first positioning device 30 is in the unlock position, and the clamping device 20 is retained stationary on the handle 10 when the first positioning device 30 is in the lock position. Additionally, the handle 10 is configured to include a plurality of first positioning sections 111 formed thereon, and the first positioning device 30 is engagable with one of the plurality of first positioning sections 111 in the lock position such that the clamping device 20 is adapted to be retained on the handle 10 at various positions. In the preferred embodiment, the plurality of first positioning sections 111 are in the form of recesses, and each of the plurality of first positioning sections 111 is equally spaced and disposed parallel from one another. In the preferred embodiment, the first positioning device 30 includes a control member 31 and a first resilient member 32 being depressible by the control member 31 when the control member 31 is operably moved by a force. However, the resilient member 32 is returnable to an original shape and urges the control member 31 when the force is removed. Preferably, the resilient member 32 is a spring.

The first positioning device 30 is received in a compartment 22 which forms in the clamping device 20 and which is in communication with the handle hole 21. Additionally the first positioning device 30 includes a first detent 33 which is moveable into the handle hole 21 to engage with one of the plurality of first positioning sections 111 via operation of the controller 31. Further, the control member 31 includes a shaft 312 and a recess 313 inset on the shaft 312 for receiving and urging the first detent 33 in engagement with one of the plurality of first positioning sections 111 by an abutting section 314, which defines a portion of the recess 313. In the preferred embodiment, the abutting section 314 is sloped from the periphery of the control member 31 to a center axis of the control member 31.

As mentioned, the control member 31 is adapted to be urged by the resilient member 32. In the preferred embodiment, the compartment 22 includes a larger diametrical section 221 and a smaller diametrical section 222, and the control member 31 includes a head 311, and the resilient member 32 is retained in the larger diametrical section 222 and is depressible by the head 311.

In order to assist the prying device 40 securely positions with respect to the handle 10, the tool may include a second positioning device 50, which is operably moveable between an unlock position and a lock position, and the prying device 40 is operably pivotal with respect to the handle 10 when the second positioning device 50 is in the unlock position, and the prying device 40 is retained stationary with respect to the handle 10 when the second positioning device 50 is in the lock position. In the preferred embodiment, the second positioning device 50 includes a controller 51 including a plurality of second detents 512, and the prying device 40 includes a first hole 41 including a periphery and a plurality of second positioning sections 411 disposed on the periphery, and the plurality of second detents 512 are releasably engagable with the plurality of second positioning sections 411 such that when the prying device 40 is retained at one of the pivoting positions with respect to the handle 10 the plurality of second detents 512 are in engagement with the plurality of second positioning sections 411.

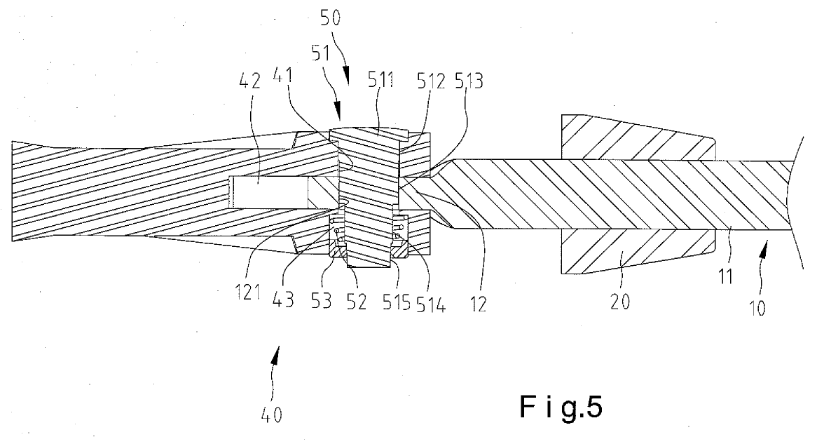

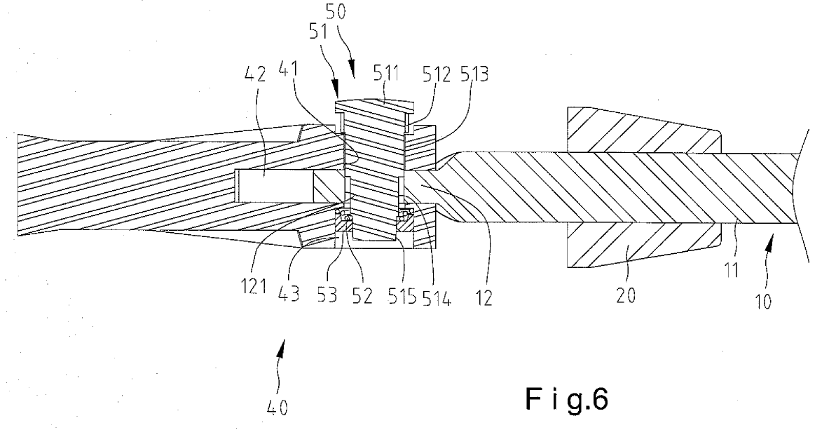

Also, in the preferred embodiment, the controller 51 connects the prying device 40 and the handle 10 together. Preferably, the pivoting end 12 of the handle 10 includes a through hole 121 through which the controller 51 is inserted. Preferably, the through hole 21 has a non-circular cross section. Moreover, the controller 51 is retained from rotation with respect to the prying device 40 and the handle 10 by including a first non-circular body section 513 and which is engagable in the through hole 121 when the second positioning device 50 is in the lock position. Further, a second resilient member 52 is utilized to resiliently urge the plurality of second detents 512 on the controller 51 to engage with the plurality of second positioning sections 411 in the first hole 41 (as shown in FIGS. 5 and 6). In the preferred embodiment, the controller 51 includes a second body section 514 on which the second resilient member 52 is mounted, also, the second resilient member 52 is retained in a cavity 43 which forms in the prying device 40 and is depressible by a retaining member 53 which is also disposed in the cavity 43. Preferably, the controller 51 includes a joint 515 on which the retaining member 53 is mounted. Preferably, the cavity 43 is spaced from the first hole 41 by a slot 42 which is utilized to receive the pivoting end 12 of the handle 10.

FIGS. 1 and 2 also show that the clamping device 20 includes a clamping section 23 including a plurality of ridges for frictionally engagement with the item to be clamped between the clamping device 20 and the prying device 40. Additionally, the first hole 41 is a countersink hole and the controller 51 includes a cap 511 retained by the enlarged part of the countersink hole 41.

FIG. 5 shows that when the prying device 40 is retained at one of the pivoting positions with respect to the handle 10, the plurality of second detents 512 are in engagement with the plurality of second positioning sections 411.

FIG. 6 shows that when the prying device 40 is pivotal with respect to the handle 10, the controller 51 is moved to make the plurality of second detents 512 away from the plurality of second positioning sections 411. In the preferred embodiment, user may operate the retaining member 53 to cause the plurality of second detents 512 away from the plurality of second positioning sections 411.

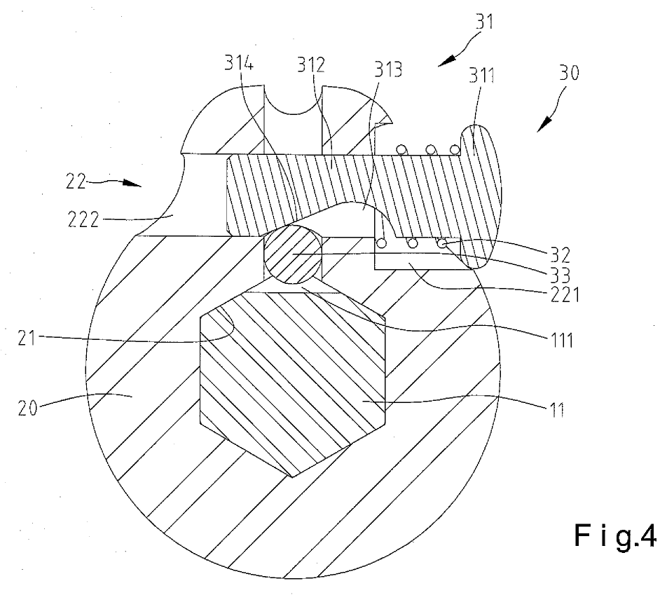

FIG. 4 shows that the first detent 33 is moved into the handle hole 21 to engage with one of the plurality of first positioning sections 111 via operation of the controller 31. Additionally, the abutting section 314 is utilized to urge the first detent 33 in engagement with one of the plurality of first positioning sections 111. Thus, the clamping device 20 is retained stationary on the handle 10.

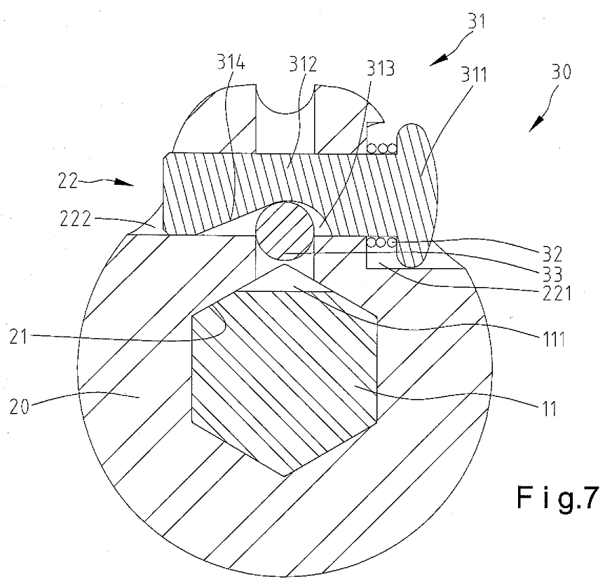

FIG. 7 shows that the first detent 33 is received in the most bottom of the recess 313 and the first detent 33 is away from any of the plurality of first positioning sections 111. Thus, the clamping device is operably moveable on the handle 10.

FIGS. 8 and 9 show that the tool is affordable to clamp items which have variable sizes therebetween, due to that the clamping device 20 is adjustably positionable on the handle 10 and the prying device 40 is positionable at various pivoting positions with respect to the handle 10. Moreover, in order to securely hold the item between the clamping device 20 and the prying device 40, the prying device 40 includes a body axis which is substantially angled with a longitudinal axis of the handle 10, and the clamping section 23 is also in an angled relationship with the longitudinal axis of the handle 10.

While the specific embodiments have been illustrated and described, numerous modifications come to mind without significantly departing from the spirit of invention and the scope of invention is only limited by the scope of accompanying claims.

What is claimed is:

1. A tool usable for prying and clamping an item comprising:
a handle including a pivoting end and a gripping end;
a clamping device adjustably positionable on the handle;
a prying device pivotally connected to the griping end of the handle and positionable at various pivoting positions with respect to the handle; and
wherein the clamping device and the prying device cooperate for holding the element therebetween; and
wherein when the item is securely clamped between the clamping device and the prying device, the prying device includes a body axis which is substantially angled with a longitudinal axis of the handle, and the clamping device also includes a clamping section in an angled relationship with the longitudinal axis of the handle.

2. The tool as claimed in claim 1 further includes a first positioning device operably moveable between an unlock position and a lock position, and wherein the clamping device is operably moveable on the handle when the first positioning device is in the unlock position, and the clamping device is retained stationary on the handle when the first positioning device is in the lock position.

3. The tool as claimed in claim 2 wherein the handle includes a plurality of first positioning sections formed thereon, and wherein the first positioning device is engagable with one of the plurality of first positioning sections in the lock position.

4. The tool as claimed in claim 3 wherein the clamping device includes a handle hole extending therethrough for receiving the handle and a compartment in communication with the handle hole for moveably receiving the first positioning device, and wherein the first positioning device includes a first detent moveable into the handle hole to engage with one of the plurality of first positioning sections.

5. The tool as claimed in claim 4 wherein the first positioning device includes a control member operably moveable in the compartment and including a shaft and a recess inset on the shaft for receiving and urging the first detent in engagement with one of the plurality of first positioning sections by an abutting section, and wherein the abutting section defines a portion of the recess.

6. The tool as claimed in claim 5 wherein the first positioning device includes a first resilient member being depressible by the control member when the control member is operably moved by a force, and wherein the resilient member is returnable to an original shape and urges the control member when the force is removed.

7. The tool as claimed in claim 1 further comprising a second positioning device operably moveable between an unlock position and a lock position, and wherein the prying device is operably pivotal with respect to the handle when the second positioning device is in the unlock position, and the prying device is retained stationary with respect to the handle when the second positioning device is in the lock position.

8. The tool as claimed in claim 7 wherein the prying device includes a first hole including a periphery and a plurality of second positioning sections disposed on the periphery, and wherein the second positioning device includes a controller including a plurality of second detents releasably engagable with the plurality of second positioning sections, and wherein when the prying device is retained at one of the pivoting positions with respect to the handle the plurality of second detents are in engagement with the plurality of second positioning sections.

9. The tool as claimed in claim 8 wherein the pivoting end of the handle includes a non-circular through hole, and wherein the controller includes a first non-circular body section engagable in the first hole and the through hole, and wherein the first body section is engaged in the through hole when the second positioning device is in the lock position, and the first body section is engaged in the first hole when the second positioning device is in the unlock position.

10. The tool as claimed in claim 8 wherein the second positioning device includes a second resilient member resiliently urging the plurality of second detents to engage with the plurality of second positioning sections.
